(19) United States
(12) Patent Application Publication
(10) Pub. No.: US 2026/0159230 A1
(43) Pub. Date: Jun. 11, 2026

(54) ROTORCRAFT FLY-BY-WIRE FLIGHT CONTROL SYSTEM

(71) Applicant: HONEYWELL INTERNATIONAL INC., Charlotte, NC (US)

(72) Inventors: Ronald Vaughan, Tempe, AZ (US); James N. Quitmeyer, Tempe, AZ (US)

(73) Assignee: HONEYWELL INTERNATIONAL INC., Charlotte, NC (US)

(21) Appl. No.: 19/179,121

(22) Filed: Apr. 15, 2025

Related U.S. Application Data
(60) Provisional application No. 63/706,151, filed on Oct. 11, 2024.

(51) Int. Cl. B64C 13/50; B64C 13/04; B64C 13/18; B64C 13/42; B64C 27/605

(52) U.S. Cl. CPC B64C 13/503; B64C 13/0421; B64C 13/18; B64C 13/42; B64C 27/605

(57) ABSTRACT

An actuator control system includes a plurality of primary flight control actuator controllers, a plurality of primary flight control actuators, a backup flight control actuator controller, and a backup flight control actuator. Each primary flight control actuator controller receives flight control position command data and generates and supplies primary flight control actuator commands. Each primary flight control actuator is associated with a different one of the primary flight control actuator controllers and receives the primary flight control actuator commands therefrom. Each primary flight control actuator supplies a primary input force to drive a flight control component. The backup flight control actuator controller receives the flight control position command data and an activation signal and, in response, generates and supplies backup flight control actuator commands. The backup flight control actuator, in response to the flight control actuator commands, supplies a backup input force to drive the flight control component.

### CROSS-REFERENCE TO RELATED APPLICATION

The present application claims benefit of prior filed U.S. Provisional Patent Application No. 63/706,151, filed Oct. 11, 2024, which is hereby incorporated by reference herein in its entirety.

### TECHNICAL FIELD

The present disclosure generally relates to rotorcraft flight control systems, and more specifically to a rotorcraft fly-by-wire flight control system.

### BACKGROUND

Some helicopter flight controls for pitch, roll, collective, and yaw are implemented with various redundant electromechanical and/or hydraulic actuator configurations, which can be relatively complex, both to implement and to operate. Thus, it is desired to move to less complex, easier to operate, fly-by-wire flight control systems. Moreover, while the redundancy of these actuator configurations provides a relatively low probability of a dual failure occurring in the flight control system, an even lower probability of such an occurrence is desired. The present disclosure provides a solution for both of these needs.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an actuator control system includes a plurality of primary flight control actuator controllers, a plurality of primary flight control actuators, a backup flight control actuator controller, and a backup flight control actuator. Each primary flight control actuator controller is adapted to receive flight control position command data from one or more flight control computers and is configured, upon receipt of the flight control position command data, to generate and supply primary flight control actuator commands. Each primary flight control actuator is associated with, and is in operable communication with, a different one of the primary flight control actuator controllers to thereby receive the primary flight control actuator commands from its associated primary flight control actuator controller. Each primary flight control actuator is configured, upon receipt of its associated primary flight control actuator commands, to supply a primary input force for use in driving a flight control component. The backup flight control actuator controller is adapted to receive the flight control position command data from the one or more flight control computers and to selectively receive the activation signal. The backup flight control actuator controller is configured, upon receipt of the flight control position command data and the activation signal, to generate and supply backup flight control actuator commands. The backup flight control actuator is in operable communication with the backup flight control actuator controller to thereby receive the backup flight control actuator commands and is configured, upon receipt of the backup flight control actuator commands, to supply a backup input force for use in driving the flight control component.

In another embodiment, a fly-by-wire control system includes a plurality of flight control computers, a plurality of primary flight control actuator controllers, a plurality of primary flight control actuators, a backup flight control actuator controller, and a backup flight control actuator. Each flight control computer is adapted to receive inceptor data from a flight control inceptor and is configured, upon receipt of the inceptor data, to generate and supply flight control position command data. Each primary flight control actuator controller is in operable communication with one or more of the flight control computers. Each primary flight control actuator controller is coupled to receive the flight control position command data from the one or more flight control computers and is configured, upon receipt of the flight control position command data, to generate and supply primary flight control actuator commands. Each primary flight control actuator is associated with, and is in operable communication with, a different one of the primary flight control actuator controllers to thereby receive the primary flight control actuator commands from its associated primary flight control actuator controller. Each primary flight control actuator is configured, upon receipt of its associated primary flight control actuator commands, to supply a primary input force for use in driving a flight control component. The backup flight control actuator controller is coupled to receive the flight control position command data from the one or more flight control computers and to selectively receive the activation signal. The backup flight control actuator controller is configured, upon receipt of the flight control position command data and the activation signal, to generate and supply backup flight control actuator commands. The backup flight control actuator is in operable communication with the backup flight control actuator controller to thereby receive the backup flight control actuator commands and is configured, upon receipt of the backup flight control actuator commands, to supply a backup input force for use in driving the flight control component.

In yet another embodiment, a flight control system includes a flight control component, a dual hydraulic actuator, and a fly-by-wire control system. The dual hydraulic actuator is coupled to receive a flow of hydraulic fluid and either a primary input force or a backup input force, the dual hydraulic actuator is configured, in response to receiving either the primary input force or the backup input force, to control the flow of the hydraulic fluid to thereby control an output force supplied to the flight control component. The fly-by-wire control system is configured to supply the input force to the dual hydraulic actuator and includes a plurality of flight control computers, a plurality of primary flight control actuator controllers, a plurality of primary flight control actuators, a backup flight control actuator controller, and a backup flight control actuator. Each flight control computer is adapted to receive inceptor data from a flight control inceptor and is configured, upon receipt of the inceptor data, to generate and supply flight control position command data. Each primary flight control actuator controller is in operable communication with one or more of the flight control computers. Each primary flight control actuator controller is coupled to receive the flight control position command data from the one or more flight control computers and is configured, upon receipt of the flight control position command data, to generate and supply primary flight control actuator commands. Each primary flight control actuator is associated with, and is in operable communication with, a different one of the primary flight control actuator controllers to thereby receive the primary flight control actuator commands from its associated primary flight control actuator controller. Each primary flight control actuator is configured, upon receipt of its associated primary flight control actuator commands, to supply the primary input force to the dual hydraulic actuator. The backup flight control actuator controller is coupled to receive the flight control position command data from the one or more of the flight control computers and to selectively receive an activation signal. The backup flight control actuator controller is configured, upon receipt of the flight control position command data and the activation signal, to generate and supply backup flight control actuator commands. The backup flight control actuator is in operable communication with the backup flight control actuator controller to thereby receive the backup flight control actuator commands and is configured, upon receipt of the backup flight control actuator commands, to supply the backup input force to the dual hydraulic actuator.

Furthermore, other desirable features and characteristics of the fly-by-wire control system will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a functional schematic diagram of one embodiment of a rotorcraft fly-by-wire flight control system; and

FIG. 2 depicts one embodiment of a fly-by-wire control system that may be used to implement the rotorcraft fly-by-wire flight control system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

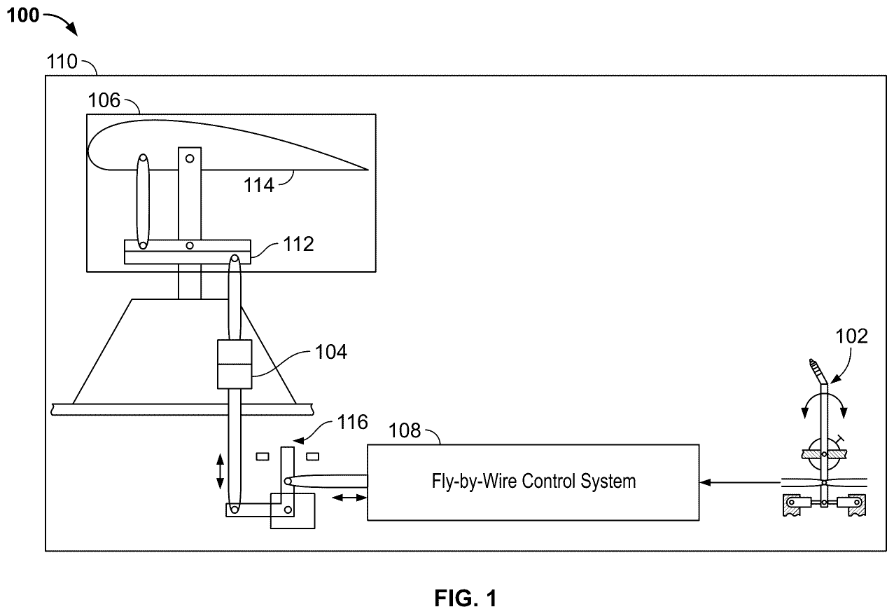

Referring to FIG. 1, a functional schematic diagram of one embodiment of a rotorcraft fly-by-wire flight control system 100 is depicted and includes a flight control inceptor 102, a dual hydraulic actuator 104, a flight control component 106, and a fly-by-wire control system 108. The flight control inceptor 102, at least in the depicted embodiment, is implemented as a control stick that, when manipulated by an operator (e.g., a pilot), generates and supplies inceptor data. Although the flight control inceptor 102 may be any one of numerous types of flight control inceptors 102, in the depicted embodiment it functions as a cyclic control stick for the rotorcraft 110.

The dual hydraulic actuator 104, as is generally known, is coupled to receive a flow of hydraulic fluid from a non-illustrated hydraulic fluid source. The dual hydraulic actuator 104 is also coupled to receive an input force and is configured, in response to the input force, to control the flow of the hydraulic fluid to thereby control an output force supplied to the flight control component 106. Although the specific flight control component 106 may vary, in the depicted embodiment the flight control component 106 includes a swash plate 112 and rotor blades 114 (only one shown) coupled together in a known, conventional manner.

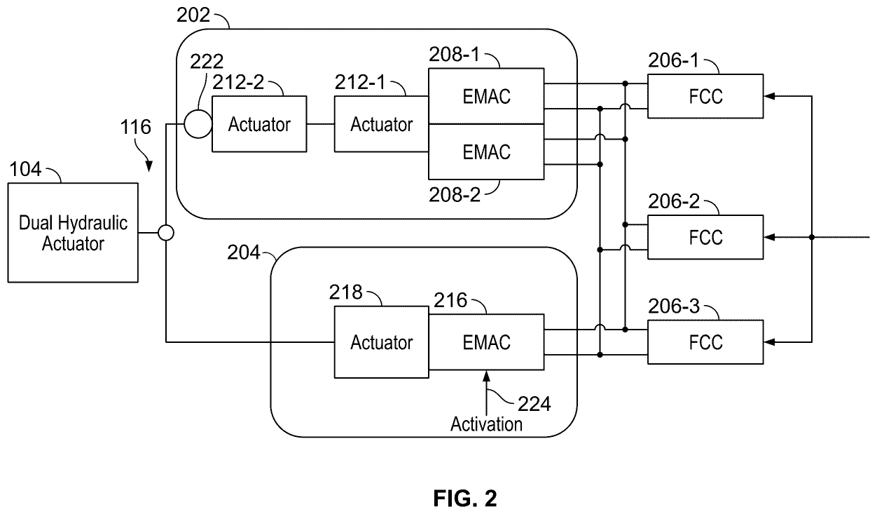

Regardless of how the flight control component is specifically implemented, the input force supplied to the dual hydraulic actuator 104 is supplied, via suitable mechanical linkage 116, from the fly-by-wire control system 108. The fly-by-wire control system 108 may be variously configured and implemented. One embodiment of the fly-by-wire control system 108 is depicted in FIG. 2, and with reference thereto will now be described.

The depicted fly-by-wire control system 108 includes a primary actuation channel 202, a backup actuation channel 204, and a plurality of flight control computers 206. The primary actuation channel 202 includes a plurality of primary flight control actuator controllers 208, and a plurality of primary flight control actuators 212. The backup actuation channel 204 includes a backup flight control actuator controller 216, and a backup flight control actuator 218.

In the depicted embodiment, system 108 includes three flight control computers 206 (206-1, 206-2, 206-3), each of which is in operable communication with the primary actuation channel 202 and the backup actuation channel 204. Moreover, in the depicted embodiment, the primary actuation channel 202 includes two primary flight control actuator controllers 208 (208-1, 208-2) and two primary flight control actuators 212 (212-1, 212-2). It will be appreciated that in other embodiments, the system 108 could include more than this number of flight control computers 206, and the primary actuation channel 202 could include more than this number primary flight control actuator controllers 208 and primary flight control actuators 212.

Regardless of the number of flight control computers 206, primary flight control actuator controllers 208, and primary flight control actuators 212, each flight control computer 206 is coupled to receive the inceptor data supplied from the flight control inceptor 102. Each flight control computer 206 is configured, upon receipt of the inceptor data, to generate and supply flight control position command data.

Each of the primary flight control actuator controllers 208 is in operable communication with one or more of the flight control computers 206. That is, in some embodiments, each primary flight control actuator controller 208 is in operable communication with a different one of the flight control computers 206, and in other embodiments, each primary flight control actuator controller 208 is in operable communication with each flight control computer 206. No matter the specific configuration, each primary flight control actuator controller 208 is coupled to receive the flight control position command data supplied from one or more of the flight control computers 206. Each of the primary flight control actuator controllers 208 is configured, upon receipt of the flight control position command data, to generate and supply primary flight control actuator commands.

Each of the primary flight control actuators 212 is associated with, and is in operable communication with, a different one of the primary flight control actuator controllers 208. For example, in one embodiment, a first one of the primary flight control actuators 212-1 is associated with, and is in operable communication with, a first one of the primary flight control actuator controllers 208-1, and a second one of the primary flight control actuators 212-2 is associated with, and is in operable communication with, a second one of the primary flight control actuator controllers 208-2. In other embodiments, however, a first one of the primary flight control actuators 212-1 may be associated with, and is in operable communication with, a second one of the primary flight control actuator controllers 208-2, and a second one of the primary flight control actuators 212-2 may be associated with, and is in operable communication with, a first one of the primary flight control actuator controllers 208-1. Regardless of the specific configuration, each primary flight control actuator 212 receives the primary flight control actuator commands from its associated primary flight control actuator controller 208, and each is configured, upon receipt of its associated primary flight control actuator commands, to supply a primary input force for use in driving a flight control component 106.

Before describing the backup actuation channel 204 in more detail, it is noted that the primary actuation channel 202 may be variously configured. For example, in one embodiment, the primary flight control actuator controllers 208 may be configured to simultaneously generate and supply primary flight control actuator commands. In this embodiment, the primary actuation channel 202 additionally includes a gearbox 222 that is coupled to each of the primary flight control actuators 212. In one embodiment, the gearbox 222 may be configured as a torque summing gearbox that is configured to mechanically sum together the primary input forces from each of the primary flight control actuators 212. With this embodiment, each primary flight control actuator 212 is fully torque capable. Thus, if one of the primary flight control actuator controllers 208 becomes inoperable and the other primary flight control actuator controller 208 remains operable, the primary input force can be supplied from only one of the primary flight control actuators 212 - the primary flight control actuator 212 that is associated with the primary flight control actuator controller 208 that remains operable.

In another embodiment, the gearbox 222 may be configured as a speed summing gearbox that is configured to sum the rotational speeds of each primary flight control actuator 212. With this latter embodiment, each primary flight control actuator 212 is fully torque capable and is configured to supply 2-times the speed. Thus, if one primary actuation channel were to become inoperable (e.g., short or jam), then the other channel can provide the full speed and torque needed.

Turning now to the backup actuation control channel 204, as was noted above, this channel includes a backup flight control actuator controller 216 and a backup flight control actuator 218. The backup flight control actuator controller 216 is coupled to receive the flight control position command data from one or more of the flight control computers 206. As FIG. 2 further depicts, the backup flight control actuator controller 216 is also coupled to selectively receive an activation signal 224. The backup flight control actuator controller 216 is configured, upon receipt of the flight control position command data and the activation signal 224, to generate and supply backup flight control actuator commands. It will be appreciated that the activation signal 224 may originate from any one or more of the components in the primary actuation control channel 202 or it may originate from a component or system external to the fly-by-wire control system 108. No matter its origin, it is generated in response to the primary actuation control channel 202 becoming inoperable.

The backup flight control actuator 218 is in operable communication with the backup flight control actuator controller 216 to thereby receive the backup flight control actuator commands therefrom. The backup flight control actuator 218 is configured, upon receipt of the backup flight control actuator commands, to supply a backup input force for use in driving the flight control component 106.

Though not mentioned to this point, it will be appreciated that the primary flight control actuators 212 and the backup flight control actuator 218 are preferably implemented using any one of numerous types of electromechanical actuators. Moreover, at least in some embodiments, each primary flight control actuator 212 is configured to supply the primary input force up to a first maximum force magnitude, and the backup flight control actuator 218 is configured to supply the backup input force up to a second maximum force magnitude, where the second maximum force magnitude is greater than the first maximum force magnitude.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An actuator control system, comprising:
a plurality of primary flight control actuator controllers, each primary flight control actuator controller adapted to receive flight control position command data from one or more flight control computers and configured, upon receipt of the flight control position command data, to generate and supply primary flight control actuator commands;
a plurality of primary flight control actuators, each primary flight control actuator associated with, and in operable communication with, a different one of the primary flight control actuator controllers to thereby receive the primary flight control actuator commands from its associated primary flight control actuator controller, each primary flight control actuator configured, upon receipt of its associated primary flight control actuator commands, to supply a primary input force for use in driving a flight control component;
a backup flight control actuator controller adapted to receive the flight control position command data from the one or more flight control computers and to selectively receive an activation signal, the backup flight control actuator controller configured, upon receipt of the flight control position command data and the activation signal, to selectively generate and supply backup flight control actuator commands; and
a backup flight control actuator in operable communication with the backup flight control actuator controller to thereby receive the backup flight control actuator commands and configured, upon receipt of the backup flight control actuator commands, to supply a backup input force for use in driving the flight control component.

2. The actuator control system of claim 1, wherein:
each primary flight control actuator is configured to supply the primary input force up to a first maximum force magnitude;
the backup flight control actuator is configured to supply the backup input force up to a second maximum force magnitude; and
the second maximum force magnitude is greater than the first maximum force magnitude.

3. The actuator control system of claim 1, wherein:
the primary flight control actuator controllers simultaneously generate and supply primary flight control actuator commands; and
the primary input force supplied from each primary flight control actuator is mechanically summed together before being supplied to the flight control component.

4. The actuator control system of claim 1, wherein:
only one of the primary flight control actuator controllers is in operable control to generate and supply the primary flight control actuator commands; and
the primary input force is supplied from the primary flight control actuator that is associated with the primary flight control actuator controller that is in operable control.

5. The actuator control system of claim 1, wherein:
each primary flight control actuator rotates at a rotational speed; and
the system further comprises a speed summing gearbox coupled to each primary flight control actuator and configured to sum the rotational speeds of each primary flight control actuator.

6. A fly-by-wire control system, comprising:
a plurality of flight control computers, each flight control computer adapted to receive inceptor data from a flight control inceptor and configured, upon receipt of the inceptor data, to generate and supply flight control position command data;
a plurality of primary flight control actuator controllers, each primary flight control actuator controller in operable communication with one or more of the flight control computers, each primary flight control actuator controller coupled to receive the flight control position command data from the one or more flight control computers and configured, upon receipt of the flight control position command data, to generate and supply primary flight control actuator commands;
a plurality of primary flight control actuators, each primary flight control actuator associated with, and in operable communication with, a different one of the primary flight control actuator controllers to thereby receive the primary flight control actuator commands from its associated primary flight control actuator controller, each primary flight control actuator configured, upon receipt of its associated primary flight control actuator commands, to supply a primary input force for use in driving a flight control component;
a backup flight control actuator controller coupled to receive the flight control position command data from the one or more flight control computers and to selectively receive an activation signal, the backup flight control actuator controller configured, upon receipt of the flight control position command data and the activation signal, to generate and supply backup flight control actuator commands; and
a backup flight control actuator in operable communication with the backup flight control actuator controller to thereby receive the backup flight control actuator commands and configured, upon receipt of the backup flight control actuator commands, to supply a backup input force for use in driving the flight control component.

7. The fly-by-wire control system of claim 6, wherein:
each primary flight control actuator is configured to supply the primary input force up to a first maximum force magnitude;
the backup flight control actuator is configured to supply the backup input force up to a second maximum force magnitude; and
the second maximum force magnitude is greater than the first maximum force magnitude.

8. The fly-by-wire control system of claim 6, wherein:
the primary flight control actuator controllers simultaneously generate and supply primary flight control actuator commands; and
the primary input force supplied from each primary flight control actuator is mechanically summed together before being supplied to the flight control component.

9. The fly-by-wire control system of claim 6, wherein:
only one of the primary flight control actuator controllers is in operable control to generate and supply the primary flight control actuator commands;
the primary input force is supplied from the primary flight control actuator that is associated with the primary flight control actuator controller that is in operable control.

10. The fly-by-wire control system of claim 6, wherein:
each primary flight control actuator rotates at a rotational speed; and
the system further comprises a speed summing gearbox coupled to each primary flight control actuator and configured to sum the rotational speeds of each primary flight control actuator.

11. A flight control system, comprising:
a flight control component;
a dual hydraulic actuator coupled to receive a flow of hydraulic fluid and either a primary input force or a backup input force, the dual hydraulic actuator configured, in response to receiving either the primary input force or the backup input force, to control the flow of the hydraulic fluid to thereby control an output force supplied to the flight control component; and
a fly-by-wire control system configured to supply the input force to the dual hydraulic actuator, the fly-by-wire control system including:
a plurality of flight control computers, each flight control computer adapted to receive inceptor data from a flight control inceptor and configured, upon receipt of the inceptor data, to generate and supply flight control position command data;
a plurality of primary flight control actuator controllers, each primary flight control actuator controller in operable communication with one or more of the flight control computers, each primary flight control actuator controller coupled to receive the flight control position command data from the one or more flight control computers and configured, upon receipt of the flight control position command data, to generate and supply primary flight control actuator commands;
a plurality of primary flight control actuators, each primary flight control actuator associated with, and in operable communication with, a different one of the primary flight control actuator controllers to thereby receive the primary flight control actuator commands from its associated primary flight control actuator controller, each primary flight control actuator configured, upon receipt of its associated primary flight control actuator commands, to supply the primary input force to the dual hydraulic actuator;
a backup flight control actuator controller coupled to receive the flight control position command data from the one or more flight control computers and to selectively receive an activation signal, the backup flight control actuator controller configured, upon receipt of the flight control position command data and the activation signal, to generate and supply backup flight control actuator commands; and
a backup flight control actuator in operable communication with the backup flight control actuator controller to thereby receive the backup flight control actuator commands and configured, upon receipt of the backup flight control actuator commands, to supply the backup input force to the dual hydraulic actuator.

12. The flight control system of claim 11, wherein:
each primary flight control actuator is configured to supply the primary input force up to a first maximum force magnitude;
the backup flight control actuator is configured to supply the backup input force up to a second maximum force magnitude; and
the second maximum force magnitude is greater than the first maximum force magnitude.

13. The flight control system of claim 11, wherein:
the primary flight control actuator controllers simultaneously generate and supply primary flight control actuator commands; and
the primary input force supplied from each primary flight control actuator is mechanically summed together before being supplied to the dual hydraulic actuator.

14. The flight control system of claim 11, wherein:
only one of the primary flight control actuator controllers is in operable control to generate and supply the primary flight control actuator commands;
the primary input force is supplied from the primary flight control actuator that is associated with the primary flight control actuator controller that is in operable control.

15. The flight control system of claim 11, wherein:
each primary flight control actuator rotates at a rotational speed; and
the system further comprises a speed summing gearbox coupled to each primary flight control actuator and configured to sum the rotational speeds of each primary flight control actuator.

16. The flight control system of claim 15, further comprising:
a mechanical linkage coupled between the speed summing gearbox and the dual hydraulic actuator.

17. The flight control system of claim 11, wherein the flight control component comprises:
a swash plate coupled to receive the output force; and
a plurality of rotor blades coupled to the swashplate.

18. The flight control system of claim 11, further comprising the flight control inceptor.

19. The flight control system of claim 18, wherein the flight control inceptor is a cyclic control stick that is configured, when manipulated by an operator, to generate and supply the inceptor data.
